(19) United States
(12) Patent Application Publication
(10) Pub. No.: US 2021/0328930 A1
(43) Pub. Date: Oct. 21, 2021

(54) PREDICTIVE QUEUE DEPTH

(71) Applicant: Intel Corporation, Santa Clara, CA (US)

(72) Inventors: Georgios NIKOLAIDIS, Mountain View, CA (US); Jeremias BLENDIN, Santa Cruz, CA (US); Changhoon KIM, Palo Alto, CA (US); Junggun LEE, Los Altos, CA (US); Rong PAN, Saratoga, CA (US); Anurag AGRAWAL, Santa Clara, CA (US); Yi LI, Fremont, CA (US)

(21) Appl. No.: 17/359,533

(22) Filed: Jun. 26, 2021

Related U.S. Application Data
(63) Continuation-in-part of application No. 16/878,466, filed on May 19, 2020.
(60) Provisional application No. 63/165,036, filed on Mar. 23, 2021.
(60) Provisional application No. 62/967,003, filed on Jan. 28, 2020.

(51) Int. Cl. H04L 12/801

(52) U.S. Cl. CPC H04L 47/127

(57) ABSTRACT

Examples described herein relate to an apparatus that includes a network interface device comprising circuitry to identify at least one congested queue, predict occupancy level of the at least one congested queue when at least one sender is predicted to receive at least one congestion notification and transmit the at least one congestion notification to the at least one sender through zero or more intermediate nodes. In some examples, to identify at least one congested queue, the circuitry is to identify the at least one congested queue based on at least one fill level. In some examples, to identify at least one congested queue, the circuitry is to identify the at least one congested queue based on at least one predicted fill level at a predicted time the at least one sender receives the at least one congestion notification.

### RELATED APPLICATIONS

The present application claims the benefit of a priority date of U.S. provisional patent application Ser. No. 63/165,036, filed Mar. 23, 2021, the entire disclosure of which is incorporated herein by reference.

This application is a continuation-in-part of U.S. patent application Ser. No. 16/878,466, filed May 19, 2020 (AC7344-US), which claims the benefit of a priority date of U.S. provisional patent application Ser. No. 62/967,003, filed Jan. 28, 2020 (AC7344-Z).

### DESCRIPTION

Data centers provide vast processing, storage, and networking resources to users. For example, automobiles, smart phones, laptops, tablet computers, or internet of things (IoT) devices can leverage data centers to perform data analysis, data storage, or data retrieval. Data centers are typically connected together using high speed networking devices such as network interfaces, switches, or routers.

When senders in a network send traffic at a rate above the available capacity, traffic experiences congestion, leading to degraded application performance and potential service level agreement (SLA) violation. A network switch may drop packets as a result of queue overflow. Senders can detect congestion either by observing the conditions that their traffic experiences (e.g., delay or packet loss), or by receiving explicit congestion notifications, such as Explicit Congestion Notification (ECN) or Backward Explicit Congestion Notification (BECN).

FIG. 1 depicts an example of use of ECN. A network device (e.g., switch 110) experiences congestion at a queue and marks a bit in an ECN field of a data packet, which can be part of an internet protocol (IP) header. Switch 110 can set a bit in an ECN field of a header of a packet that caused congestion. Depending on an implementation, the marking can be performed prior to the enqueuing of the data packet into the congested queue (e.g., at switch ingress) or performed after the packet is dequeued from the congested queue (e.g., at switch egress). In either case, after the ECN-marked data packet reaches destination 120, destination 120 sends congestion information to sender 100 via a separate acknowledgement (ACK) packet or marking on a reverse-direction data packet. Sender 100 can react to the congestion information in a variety of ways such as, but not limited to, reducing a rate of packet transmission or pausing packet transmission to the congested switch 110, or a particular congested queue in switch 110.

Switch 110 can apply Random Early Detection (RED) to decide whether to either proactively drop a received packet before buffer space is exhausted or mark the received packet with ECN, hence informing sender 100 and/or destination 120 of congestion. RED can involve calculating an average queue occupancy, and if the average queue occupancy is between a lower threshold and a higher threshold, switch 110 marks the received packet or drops the received packet, with a drop probability that increases with queue occupancy. If the queue occupancy is above the higher threshold, switch 110 can mark or drop the received packet. RED can be used to inform end hosts of congestion in the network, but by the time queue occupancy crosses the higher threshold, sender 100 may react too late to the congestion.

Weighted Random Early Detection (WRED) is an extension to RED that allows for different classes of traffic within the same queue to have different marking probability. Adaptive Random Early Detection adjusts dynamically the marking probability so that the queue size remains in between the higher and lower thresholds.

### BRIEF DESCRIPTION OF THE DRAWINGS

FIG. 1 depicts an example of use of Explicit Congestion Notification (ECN).

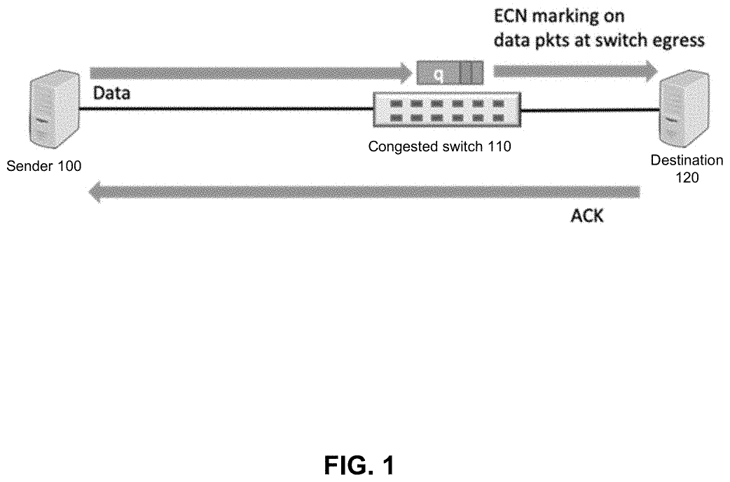

FIG. 2 depicts an example system.

FIG. 3 depicts an example of relationship between packet drop probability and queue occupancy.

FIG. 4 depicts an example of queue level over time.

FIG. 5 depicts an example process.

FIG. 6 depicts an example network interface device.

FIG. 7 depicts a system.

### DETAILED DESCRIPTION

Datacenters can experience a type of traffic phenomenon called incast. With incast, multiple senders attempt to send packets to a same destination at the same or overlapping times, leading to a very rapid increase in network traffic at one or more egress ports of a network device such as a switch. Setting a threshold to trigger ECN transmission may not reduce congestion fast enough as congestion rapidly builds up so that mitigation at the sender or senders may not occur fast enough to alleviate congestion at the network device. Detecting incast and alleviating incast as soon as possible can dramatically improve network performance, leading to fewer packet drops, reduced use of priority frame control (PFC) frames that can cause further delays in flow completion time, and overall improved application performance.

A network interface device can utilize one or more processors or circuitry to predict buffer or queue depth at a predicted time when a sender receives a congestion notification from a receiver based on a rate of buffer occupancy change. The network interface device can track a rate of change of a buffer or queue and use the rate to predict occupancy level of the buffer or queue in the future, such as a time that one or more senders receive a congestion notification message either from a destination receiver or the congested node. One or more processors or circuitry in the network interface device and/or host can calculate a derivative of queue occupancy or rate of queue occupancy increase or decrease and predict what will be the queue size based on when one or more senders receive or process a congestion notification. A time that one or more senders receive a congestion notification message either from a destination receiver or the congested node can be based on round-trip time (RTT) or fractions or multiples thereof. RTT can represent (i) a time from a first network interface device sending a packet to a second network interface device to the time the second network interface device receives the packet plus (ii) a time taken for the first network interface device to receive an acknowledgement (ACK) of packet receipt from the second network interface device. For example, predicted occupancy queue level can be n*RTT from a time that congestion is detected, a time that a packet with a congestion notification is transmitted from the network interface device with the congested queue, or other times. In some examples, n≥0.

in some examples, a base RTT value can be configurable by a control plane (e.g., driver or orchestrator) and can be set according to the network design and conditions. For example, the base RTT value can be based on network conditions and bandwidth. For example, the base RTT value can be based on sensitivity to packet drops with a lower RTT set for lower sensitivity to packet drops or a higher RTT set for higher sensitivity to packet drops. For example, the base RTT value can be set as a higher value to avoid packet drops, at the cost of reduced throughput due to incorrect incast detection.

A network interface device can detect a queue build-up at its infancy and alert the one or more senders to take remedial actions such as reducing transmission rate to the congested queue or pausing transmission to the congested queue. If the rate of increase of queue occupancy exceeds a threshold level, rapid queue depth increases can be the result of incast, leading to packet drops if the one or more senders are not notified in time to reduce their transmission rate. In some examples, the congestion notification can identify occurrence of incast at one or more queues and/or one or more egress ports.

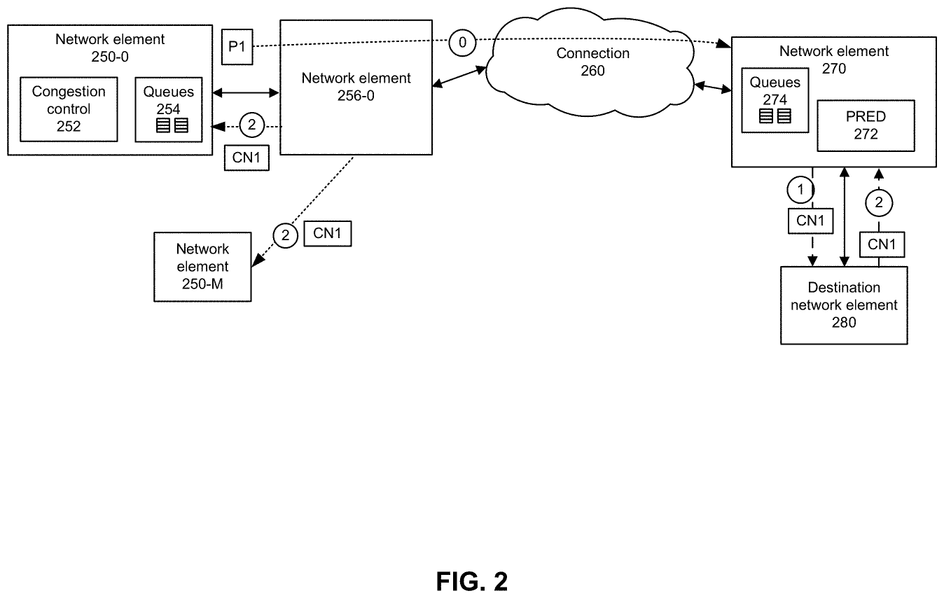

FIG. 2 depicts an example system. In this example, network element 250-0 sends one or more packets to endpoint network element 280 through network element 256-0, connection 260, and network element 270. Predictive Random Early Detection (PRED) circuitry 272 can detect congestion based on one or more of: a queue level equaling or exceeding a threshold level and/or a rate of change of queue occupancy of one or more of queues 274. In some examples, if a congestion level of a queue exceeds a threshold, PRED 272 can cause a congestion notification (CN1), described herein, to be sent to one or more senders (e.g., network elements 250-0 to 250-M). In some examples, if a congestion level of a queue is expected to equal or exceed a threshold by a time one or more senders receive a congestion notification (CN1), PRED 272 can cause a congestion notification, described herein, to be sent to one or more senders. A network device, network interface device, or network element can be implemented as one or more of: network interface controller (NIC), SmartNIC, router, switch, forwarding element, infrastructure processing unit (IPU), or data processing unit (DPU).

For example, PRED 272 can detect congestion at one or more of queues 274 based on one or more of: overflow of packets at an ingress port, overflow of packets at an egress queue of queues 274, overflow of packets at an egress port, incast level exceeding a threshold (e.g., more traffic to egress port than egress port can handle), a packet drop rate in a transmit pipeline such as egress queues 274 or intermediate queues that feed egress queues 274 exceeding an upper threshold level, bandwidth limit being exceeded, one or more queue depths of queues 274 being exceeded, or one or more queue depths of queues 274 predicted to be exceeded at a time a congestion notification is received or processed by a sender. In some examples, one or more queues can be assigned space in a shared pool space so that the upper threshold can be set based on available queue space and available shared pool space. An egress queue 274 can be used to store packets associated with an egress port prior to transmission of the packets through the egress port. In some examples, queues 274 can represent queues that store packets prior to packet processing, such as ingress queues. Based on detected congestion in a queue, network element 270 can drop one or more packets to alleviate or avoid congestion.

PRED 272 can predict one or more queue congestion levels at a time when one or more senders to the congested one or more queues of queues 274, such as network element 250-0 and/or network element 250-M, receive or process at least one congestion notification. In response to detecting congestion, PRED 272 can cause a packet to include CN1 and predicted queue congestion level. In some examples, a configuration indicator, setting or file from a local or remote control plane can configure PRED 272 to cause congestion notification, prediction of queue level(s), and inclusion of the predicted queue level(s).

In some examples, PRED 272 can calculate a time elapsed since a start of the measurement period and an amount a queue depth increased during the elapsed time. The measurement period can be a time between two successive packet stores in a queue of interest or other time intervals. In some examples, time between packet stores can be based on a time between receipt of one packet or multiple packets. For example, every tenth packet can represent a start of a timer so that a timer can start at receipt of packet 1 and for packets 2-10, calculation is made of the elapsed time is made since receipt of packet 1. Receipt of packet 11 can reset the timer, so that for packets 12-20, receipt of packet 11 can be used as a starting point for a timer.

If the time between packets stored in a queue of interest is less than a threshold level, the receive rate exceeds a threshold and PRED 272 can determine a predicted queue depth when one or more senders receive a congestion notification and the predicted queue depth. Other manners of determining a rate of queue level changes such as linear, quadratic, exponential, or others can be used and a determination if the rate exceeds a threshold can be made based on the rate of queue level changes. One or multiple predicted queue depths can be determined and sent to one or more senders (e.g., network element 250-0 to 250-M, where M≥1). Based on a queue build-up rate, PRED 272 can add an additional value to a current queue depth to predict future depth of the queue when one or more senders receive or process notice of an impending incast or congestion.

PRED 272 can decide whether to set a congestion notification (CN1) indicator for one or more packets or not for different classes of traffic within the same queue, such as based on WRED. PRED 272 can cause at least one packet that is to be transmitted from network element 270 to include a congestion notification (CN1). In some examples, based on a congestion level of a queue being met or exceeded, PRED 272 can set a congestion notification (CN1) indicator for one or more packets. In some examples, CN1 can include a congestion notification and an expected queue depth level when one or more senders, that send packets to the one or more queues 274 that are identified as congested, receive or process the congestion notification. For example, the packet with CN1 can be a packet that caused or is associated with congestion of one or more queues 274.

A congestion notification can be implemented based on ECN, in a manner consistent with RFC 3168 (2001). For example, a congestion notification can be sent using In-band Network Telemetry (INT) (e.g., ONF/P4.org INT v2.0). In some examples, telemetry reports can be sent to a remote telemetry collector. For example, packet formats described in Internet Engineering Task Force (IETF) In-situ Operations, Administration, and Maintenance (IOAM) (draft) can be used to convey congestion notification information. For example, packet formats described in IETF Inband Flow Analyzer (IFA) can be used to convey congestion notification. Backward Explicit Congestion Notification (BECN) can be used to convey congestion notification. In some examples, a congestion notification can include a priority frame control (PFC) frame in accordance with IEEE 8021Qbb-2011.

In some examples, a limit can be placed per amount of time on a number of congestion notifications sent to at least one sender. In some examples, no limit can be placed on a number of congestion notifications sent to at least one sender.

Network element 270 can enqueue the received packet in the congested queue for transmission to destination network element 280. Network element 270 can provide congestion notification (CN1) related information to notify destination network element 280 of congestion. Destination network element 280 can deliver congestion notification to one or more senders (e.g., network elements 250-0 to 250-M) via ACK messages or NACK messages or other packets.

A packet may be used herein to refer to various formatted collections of bits that may be sent across a network, such as Ethernet frames, IP packets, TCP segments, UDP datagrams, etc. Also, as used in this document, references to L2, L3, L4, and L7 layers (or layer 2, layer 3, layer 4, and layer 7) are references respectively to the second data link layer, the third network layer, the fourth transport layer, and the seventh application layer of the OSI (Open System Interconnection) layer model.

A flow can be a sequence of packets being transferred between two endpoints, generally representing a single session using a known protocol. Accordingly, a flow can be identified by a set of defined tuples and, for routing purpose, a flow is identified by the two tuples that identify the endpoints, i.e., the source and destination addresses. For content-based services (e.g., load balancer, firewall, Intrusion detection system etc.), flows can be discriminated at a finer granularity by using N-tuples (e.g., source address, destination address, IP protocol, transport layer source port, and destination port). A packet in a flow is expected to have the same set of tuples in the packet header.

A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

Based on receipt of a congestion notification, network element 250-0 can pause its transmission of packets towards the congested device (e.g., destination network element 280 or a congested queue or port of network element 270). For example, congestion control 252 can perform pausing of transmission of packets to network element 270 for a pause time. In some examples, a source device can reduce a transmit rate to the congested queue. For example, a first receipt of a congestion notification for a flow can cause the transmission rate to decrease by X %, and subsequent receipts of congestion notification for a flow can cause the transmission rate to decrease by larger amounts. In some examples, if a sender network interface device receives another congestion notification for a queue that is currently paused, the pause end time of the queue can be updated with a pause end time in the congestion notification by increasing the current pause end time by the pause end time in the congestion notification or replacing the pause end time for the queue with the pause end time in the congestion notification.

Connection 260 and any communication between network elements can be compatible or compliant with one or more of: Internet Protocol (IP), Ethernet (IEEE 802.3), remote direct memory access (RDMA), InfiniBand, FibreChannel, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect (PCIe), Intel QuickPath Interconnect (QPI), Intel Ultra Path Interconnect (UPI), Intel On-Chip System Fabric (IOSF), Omnipath, Compute Express Link (CXL), HyperTransport, high-speed fabric, NVLink, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, fabric interface, and variations thereof. Data can be copied or stored to virtualized storage nodes using a protocol such as non-volatile memory express (NVMe) over Fabrics (NVMe-oF) or NVMe.

The following describes an example operation of the system. For example, at (0), network element 270 receives a packet P1 from network element 250-0. Network element 270 detects congestion at a queue and at (1) sends CN1 to network destination network element 280. At (2), destination network element 280 can send CN1 to network element 250-0 and/or network element 250-M through network element 270 or another device or devices.

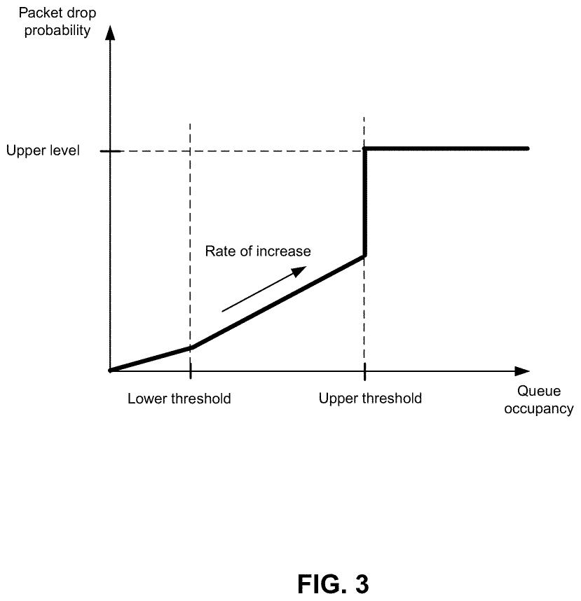

FIG. 3 depicts an example of relationship between packet drop probability and queue occupancy. In some examples, packet drop probability increases after queue occupancy passes a lower threshold and achieves an upper level probability (e.g., approximately 100%) after queue occupancy passes an upper threshold. In some examples, a rate of increase of the queue occupancy over time before and/or after the lower threshold is passed can be used to predict a queue depth at a time that a receiver receives or processes a congestion notification.

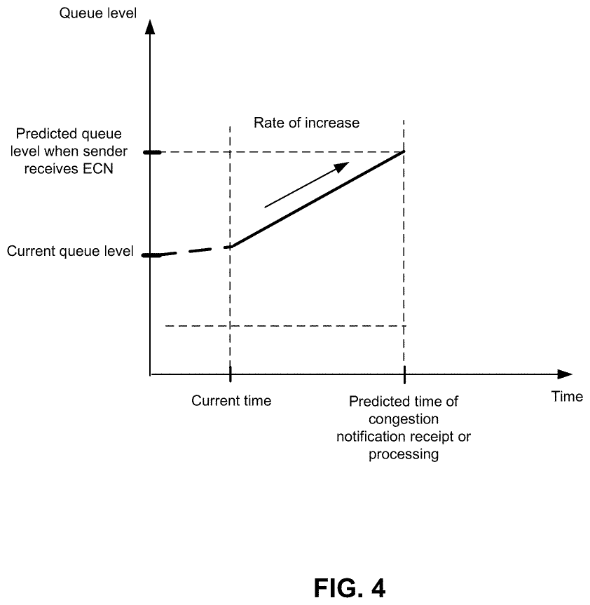

FIG. 4 depicts an example of queue level changing over time. For example, a network device with a queue can predict a queue depth at a time that a receiver receives or processes a congestion notification. A rate of increase can be determined based on a change over an amount of time using a linear, quadratic, or exponential relationships. A predicted queue level can be based on a current queue level plus an expected increase in the queue level based on the rate of increase and an expected time difference between the predicted time of congestion notification receipt or processing at the sender and a time at which the congestion notification is sent from the network device or a time when the network device determines to send a congestion notification. The predicted time of congestion notification receipt or processing at the sender can be based on n*RTT and configured by a control plane, for example. A time of processing at the sender of the congestion notification can include an expected time when a decision is made as to how, or whether, to mitigate or alleviate congestion by the sender. Note that in some examples, prediction of queue level can be triggered by detection of a congested queue. Note that in some examples, prediction of queue level can be performed regardless of whether a queue is currently congested and if the queue is predicted to be congested at a sender receives or processes a congestion notification, a congestion notification can be generated.

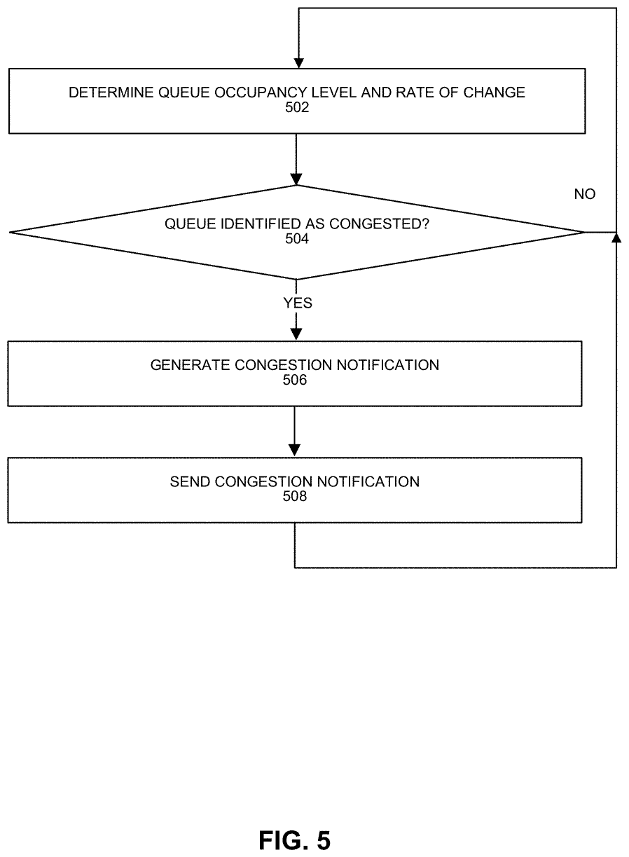

FIG. 5 depicts an example process. The process can be performed by a network interface device to detect and attempt to reduce queue congestion. At 502, the network interface device can determine a queue occupancy level and queue occupancy rate of change. The queue occupancy rate of change can represent a rate of increase in queue occupancy in terms of a change in number of packets or bytes over time.

At 504, the network interface device can determine if a queue is congested. For example, the current queue occupancy level in terms of number of packets or bytes stored can be considered against a congestion threshold to determine if the queue is congested such that if the current queue occupancy level in terms of number of packets or bytes stored exceed the congestion threshold, the queue is identified as a congested queue. In some examples, if the expected queue occupancy level increased according to the rate of change yields an occupancy level at a time that a sender is to receive or process a congestion notification and the occupancy level is greater than or equal to the congestion threshold, the queue can be identified as a congested queue. If the queue is identified as congested, the process can continue to 506. If the queue is not considered congested, the process can continue to 502.

At 506, the network interface device can generate a congestion notification. A congestion notification can include one or more of: an indication of queue congestion, identifier of the congested queue, identifier of one or more flows stored to a congested queue, a predicted queue depth at a time when the sender network interface device receives congestion notification or when the sender network interface device and/or a host processes the congestion notification. The predicted queue depth can be based on a queue depth at a time a congestion is detected plus an expected queue depth based on a rate of increase of queue depth during a time interval from transmission of the congestion notification to when the sender network interface device is expected to receive the congestion notification or sender network interface device and/or a host processes congestion notification. The time interval can be a multiple of RTT, where the multiple is 0 or more and can be a decimal. Processing congestion notification can include determining whether to reduce transmit rate of packets that are to be stored in the queue that is identified as congested. The congestion notification can include ECN although other notifications can be used such as BECN.

At 508, the network interface device can send at least one packet with the congestion notification to identify a congested queue. The at least one packet can be a cause of congestion at a queue or received after congestion at a queue is detected. The at least one packet can include a queue depth, or indication the queue is congested. The packet can be transmitted to a destination node via one or more intermediate nodes or sent to the sender directly. The sender can be identified by its source internet protocol (IP) address or one or more tuples in a packet header associated with a packet to be stored in a congested queue. The network interface device can include or access a tracker of queue-to-senders. The congestion notification can be sent to a destination receiver, which sends the congestion notification to one or more senders of packets to the congested queue. BECN can be sent directly to one or more senders of packets to the congested queue. Various examples can send congestion notifications to multiple devices that send packets to the congested queue. The process can return to 502.

When a queue changes from congested to non-congested state, congestion notifications can change from marking one or more packets with a congestion notification of a queue to marking no packet with a congestion notification of a queue.

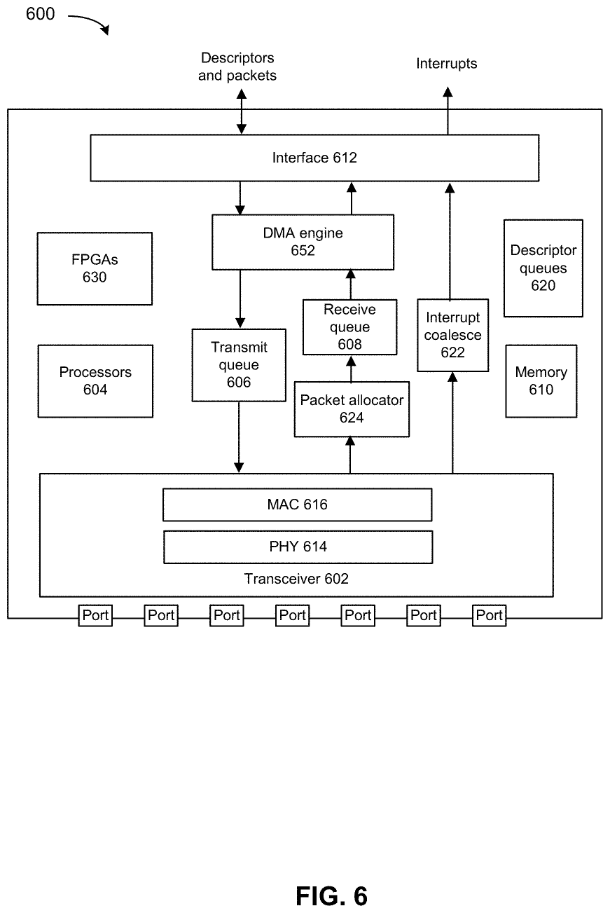

FIG. 6 depicts a network interface. Various processor resources in the network interface can predict a queue level at a time when a sender of packets to a congested queue receives or processes a congestion notification and send the congestion notification with predicted queue level to a sender of packets to the queue, as described herein. In some examples, network interface 600 can be implemented as a network interface controller, network interface card, network device, network interface device, a host fabric interface (HFI), or host bus adapter (HBA), and such examples can be interchangeable. Network interface 600 can be coupled to one or more servers using a bus, PCIe, CXL, or DDR. Network interface 600 may be embodied as part of a system-on-a-chip (SoC) that includes one or more processors, or included on a multichip package that also contains one or more processors.

Some examples of network device 600 are part of an Infrastructure Processing Unit (IPU) or data processing unit (DPU) or utilized by an IPU or DPU. An xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a central processing unit (CPU). The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 604, transmit queue 606, receive queue 608, memory 610, and bus interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to perform MAC address filtering on received packets, process MAC headers of received packets by verifying data integrity, remove preambles and padding, and provide packet content for processing by higher layers. MAC circuitry 616 can be configured to assemble data to be transmitted into packets, that include destination and source addresses along with network control information and error detection hash values.

Processors 604 can be any a combination of a: processor, core, graphics processing unit (GPU), field programmable gate array (FPGA), application specific integrated circuit (ASIC), or other programmable hardware device that allow programming of network interface 600. For example, a “smart network interface” or SmartNIC can provide packet processing capabilities in the network interface using processors 604.

Processors 604 can include a programmable processing pipeline that is programmable by P4, C, Python, Broadcom Network Programming Language (NPL), or x86 compatible executable binaries or other executable binaries. A programmable processing pipeline can include one or more match-action units (MAUs) that can determine queue levels, determine whether a queue is congested, predicts a queue level at a time when a congestion notification is received or processed by at least one sender of packets to the congested queue, and selectively triggers transmission of a congestion notification with predicted queue level to at least one sender of packets to the congested queue. Processors, FPGAs, other specialized processors, controllers, devices, and/or circuits can be used utilized for packet processing or packet modification. Ternary content-addressable memory (TCAM) can be used for parallel match-action or look-up operations on packet header content.

Packet allocator 624 can provide distribution of received packets for processing by multiple CPUs or cores using timeslot allocation described herein or receive side scaling (RSS). When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Bus interface 612 can provide an interface with host device (not depicted). For example, bus interface 612 can be compatible with PCI, PCI Express, PCI-x, Serial ATA, and/or USB compatible interface (although other interconnection standards may be used).

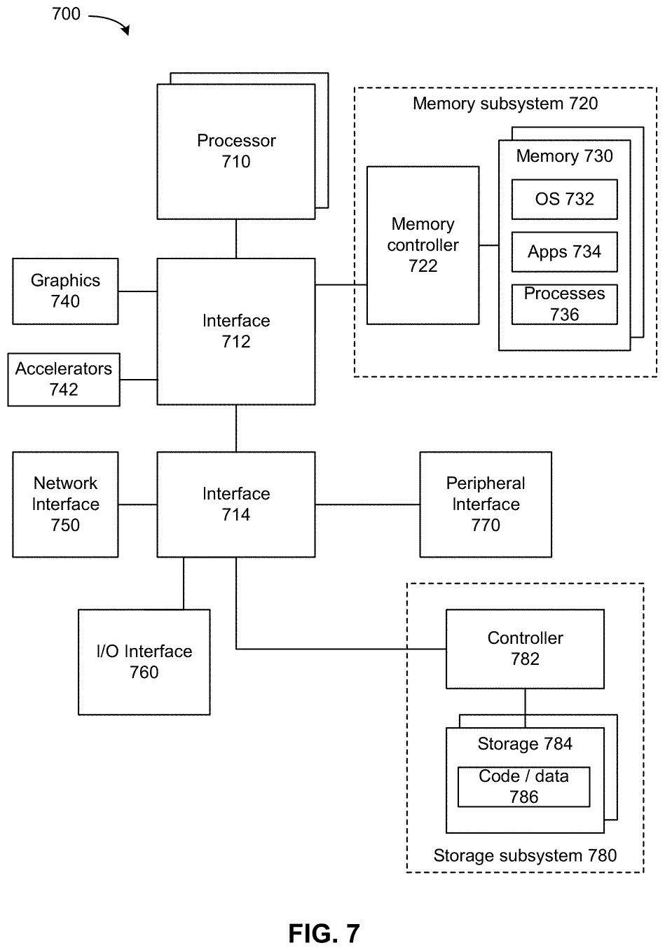

FIG. 7 depicts an example computing system. Various embodiments can use components of system 700 (e.g., processor 710, network interface 750, and so forth) to predict queue level at a time when a sender of packets to a congested queue receives or processes a congestion notification and send the congestion notification with predicted queue level to a sender of packets to the congested queue, as described herein. System 700 includes processor 710, which provides processing, operation management, and execution of instructions for system 700. Processor 710 can include any type of microprocessor, central processing unit (CPU), graphics processing unit (GPU), processing core, or other processing hardware to provide processing for system 700, or a combination of processors. Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 700 includes interface 712 coupled to processor 710, which can represent a higher speed interface or a high throughput interface for system components that needs higher bandwidth connections, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a fixed function or programmable offload engine that can be accessed or used by a processor 710. For example, an accelerator among accelerators 742 can provide compression (DC) capability, cryptography services such as public key encryption (PKE), cipher, hash/authentication capabilities, decryption, or other capabilities or services. In some embodiments, in addition or alternatively, an accelerator among accelerators 742 provides field select controller capabilities as described herein. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 742 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

In some examples, OS 732 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others. In some examples, a driver can configure network interface 750 to predict queue level at a time when a sender of packets to a queue receives or processes a congestion notification and send the congestion notification with a predicted queue level to a sender of packets to the congested queue, as described herein.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory.

In one example, system 700 includes one or more input/output (I/O) interface(s) 760. I/O interface 760 can include one or more interface components through which a user interacts with system 700 (e.g., audio, alphanumeric, tactile/touch, or other interfacing). Peripheral interface 770 can include any hardware interface not specifically mentioned above. Peripherals refer generally to devices that connect dependently to system 700. A dependent connection is one where system 700 provides the software platform or hardware platform or both on which operation executes, and with which a user interacts.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as DDR3 (Double Data Rate version 3, original release by JEDEC (Joint Electronic Device Engineering Council) on Jun. 16, 2007). DDR4 (DDR version 4, initial specification published in September 2012 by JEDEC), DDR4E (DDR version 4), LPDDR3 (Low Power DDR version3, JESD209-3B, August 2013 by JEDEC), LPDDR4) LPDDR version 4, JESD209-4, originally published by JEDEC in August 2014), WIO2 (Wide Input/output version 2, JESD229-2 originally published by JEDEC in August 2014, HBM (High Bandwidth Memory, JESD325, originally published by JEDEC in October 2013, LPDDR5 (currently in discussion by JEDEC), HBM2 (HBM version 2), currently in discussion by JEDEC, or others or combinations of memory technologies, and technologies based on derivatives or extensions of such specifications. The JEDEC standards are available at www.jedec.org.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), resistive memory including metal oxide base, oxygen vacancy base and Conductive Bridge Random Access Memory (CB-RAM), nanowire memory, ferroelectric random access memory (FeRAM, FRAM), magneto resistive random access memory (MRAM) that incorporates memristor technology, spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of one or more of the above, or other memory.

A power source (not depicted) provides power to the components of system 700. More specifically, power source typically interfaces to one or multiple power supplies in system 700 to provide power to the components of system 700. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 700 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMB A) interconnect, OpenCAPI, Gen-Z, Infinity Fabric (IF), Cache Coherent Interconnect for Accelerators (COX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes a network interface device comprising circuitry to: identify at least one congested queue, predict occupancy level of the at least one congested queue when at least one sender is predicted to receive at least one congestion notification and transmit the at least one congestion notification to the at least one sender through zero or more intermediate nodes.

Example 2 includes one or more examples, wherein to identify at least one congested queue, the circuitry is to identify the at least one congested queue based on at least one fill level.

Example 3 includes one or more examples, wherein to identify at least one congested queue, the circuitry is to identify the at least one congested queue based on at least one predicted fill level at a predicted time the at least one sender receives the at least one congestion notification.

Example 4 includes one or more examples, wherein to predict occupancy level of the at least one congested queue at a predicted time the at least one sender receives at least one congestion notification, the circuitry is to: determine a rate of change of occupancy level of at least one congested queue; determine a predicted time at which the at least one sender receives at least one congestion notification; and determine the occupancy level of at least one congested queue at the predicted time the at least one sender receives the at least one congestion notification.

Example 5 includes one or more examples, wherein the predicted time at which the at least one sender receives at least one congestion notification comprises a predicted time at which the at least one sender receives or processes at least one congestion notification.

Example 6 includes one or more examples, wherein the at least one congestion notification comprises one or more of: an Explicit Congestion Notification (ECN), a Backward Explicit Congestion Notification (BECN), or the predicted occupancy level of the at least one congested queue.

Example 7 includes one or more examples, wherein the transmit the at least one congestion notification to the at least one sender through zero or more intermediate nodes is based, at least, in part, on a rate of increase in congestion of the at least one congested queue.

Example 8 includes one or more examples, wherein the circuitry comprises a packet processing pipeline including one or more match-action units (MAUs).

Example 9 includes one or more examples, wherein the network interface device comprises one or more of: network interface controller (NIC), SmartNIC, router, switch, forwarding element, infrastructure processing unit (IPU), or data processing unit (DPU).

Example 10 includes one or more examples, and a method comprising: at a network interface device: identifying at least one congested queue, predicting occupancy level of the at least one congested queue when at least one sender receives at least one congestion notification, and transmitting the at least one congestion notification to the at least one sender through zero or more intermediate nodes.

Example 11 includes one or more examples, wherein the identifying at least one congested queue is based on at least one predicted fill level at a predicted time the at least one sender receives the at least one congestion notification.

Example 12 includes one or more examples, wherein the predicting occupancy level of the at least one congested queue when at least one sender receives at least one congestion notification comprises: determining a rate of change of occupancy level of at least one queue; determining a predicted time at which the at least one sender receives at least one congestion notification; and determining the occupancy level of the at least one congested queue at the predicted time the at least one sender receives the at least one congestion notification.

Example 13 includes one or more examples, wherein the predicted time at which the at least one sender receives at least one congestion notification comprises a predicted time at which the at least one sender receives or processes at least one congestion notification.

Example 14 includes one or more examples, wherein the at least one congestion notification comprises one or more of: an Explicit Congestion Notification (ECN), a Backward Explicit Congestion Notification (BECN), or the predicted occupancy level of the at least one congested queue.

Example 15 includes one or more examples, wherein the network interface device comprises one or more of: network interface controller (NIC), SmartNIC, router, switch, forwarding element, infrastructure processing unit (IPU), or data processing unit (DPU).

Example 16 includes one or more examples, and includes a computer-readable medium comprising instructions stored thereon, that if executed by one or more processors, cause the one or more processors to: configure a network interface device, when operational, to: identify at least one congested queue, predict occupancy level of the at least one congested queue at a predicted time when at least one sender receives at least one congestion notification, and transmit the at least one congestion notification to the at least one sender through zero or more intermediate nodes.

Example 17 includes one or more examples, wherein the identify at least one congested queue comprises identify the at least one congested queue based a fill level or based on at least one predicted fill level at the predicted time the at least one sender receives the at least one congestion notification.

Example 18 includes one or more examples, wherein to predict occupancy level of the at least one congested queue at a predicted time when at least one sender receives at least one congestion notification, the network interface device, when operational, is to: determine a rate of change of occupancy level of at least one queue; determine a predicted time at which the at least one sender receives at least one congestion notification; and determine the occupancy level of at least one congested queue at the predicted time the at least one sender receives the at least one congestion notification.

Example 19 includes one or more examples, wherein the predicted time at which the at least one sender receives at least one congestion notification comprises a predicted time at which the at least one sender receives or processes at least one congestion notification.

Example 20 includes one or more examples, wherein the network interface device comprises one or more of: network interface controller (NIC), SmartNIC, router, switch, forwarding element, infrastructure processing unit (IPU), or data processing unit (DPU).

What is claimed is:

1. An apparatus comprising:
a network interface device comprising circuitry to:
identify at least one congested queue, predict occupancy level of the at least one congested queue when at least one sender is predicted to receive at least one congestion notification and
transmit the at least one congestion notification to the at least one sender through zero or more intermediate nodes.

2. The apparatus of claim 1, wherein to identify at least one congested queue, the circuitry is to identify the at least one congested queue based on at least one fill level.

3. The apparatus of claim 1, wherein to identify at least one congested queue, the circuitry is to identify the at least one congested queue based on at least one predicted fill level at a predicted time the at least one sender receives the at least one congestion notification.

4. The apparatus of claim 1, wherein to predict occupancy level of the at least one congested queue at a predicted time the at least one sender receives at least one congestion notification, the circuitry is to:
determine a rate of change of occupancy level of at least one congested queue;
determine a predicted time at which the at least one sender receives at least one congestion notification; and
determine the occupancy level of at least one congested queue at the predicted time the at least one sender receives the at least one congestion notification.

5. The apparatus of claim 4, wherein the predicted time at which the at least one sender receives at least one congestion notification comprises a predicted time at which the at least one sender receives or processes at least one congestion notification.

6. The apparatus of claim 1, wherein the at least one congestion notification comprises one or more of: an Explicit Congestion Notification (ECN), a Backward Explicit Congestion Notification (BECN), or the predicted occupancy level of the at least one congested queue.

7. The apparatus of claim 1, wherein the transmit the at least one congestion notification to the at least one sender through zero or more intermediate nodes is based, at least, in part, on a rate of increase in congestion of the at least one congested queue.

8. The apparatus of claim 1, wherein the circuitry comprises a packet processing pipeline including one or more match-action units (MAUs).

9. The apparatus of claim 1, wherein the network interface device comprises one or more of: network interface controller (NIC), SmartNIC, router, switch, forwarding element, infrastructure processing unit (IPU), or data processing unit (DPU).

10. A method comprising:
at a network interface device:
identifying at least one congested queue,
predicting occupancy level of the at least one congested queue when at least one sender receives at least one congestion notification, and
transmitting the at least one congestion notification to the at least one sender through zero or more intermediate nodes.

11. The method of claim 10, wherein the identifying at least one congested queue is based on at least one predicted fill level at a predicted time the at least one sender receives the at least one congestion notification.

12. The method of claim 10, wherein the predicting occupancy level of the at least one congested queue when at least one sender receives at least one congestion notification comprises:
determining a rate of change of occupancy level of at least one queue;
determining a predicted time at which the at least one sender receives at least one congestion notification; and
determining the occupancy level of the at least one congested queue at the predicted time the at least one sender receives the at least one congestion notification.

13. The method of claim 12, wherein the predicted time at which the at least one sender receives at least one congestion notification comprises a predicted time at which the at least one sender receives or processes at least one congestion notification.

14. The method of claim 10, wherein the at least one congestion notification comprises one or more of: an Explicit Congestion Notification (ECN), a Backward Explicit Congestion Notification (BECN), or the predicted occupancy level of the at least one congested queue.

15. The method of claim 10, wherein the network interface device comprises one or more of:
network interface controller (NIC), SmartNIC, router, switch, forwarding element, infrastructure processing unit (IPU), or data processing unit (DPU).

16. A computer-readable medium comprising instructions stored thereon, that if executed by one or more processors, cause the one or more processors to:
configure a network interface device, when operational, to:
identify at least one congested queue,
predict occupancy level of the at least one congested queue at a predicted time when at least one sender receives at least one congestion notification, and
transmit the at least one congestion notification to the at least one sender through zero or more intermediate nodes.

17. The computer-readable medium of claim 16, wherein the identify at least one congested queue comprises identify the at least one congested queue based a fill level or based on at least one predicted fill level at the predicted time the at least one sender receives the at least one congestion notification.

18. The computer-readable medium of claim 16, wherein to predict occupancy level of the at least one congested queue at a predicted time when at least one sender receives at least one congestion notification, the network interface device, when operational, is to:
determine a rate of change of occupancy level of at least one queue;
determine a predicted time at which the at least one sender receives at least one congestion notification; and
determine the occupancy level of at least one congested queue at the predicted time the at least one sender receives the at least one congestion notification.

19. The computer-readable medium of claim 18, wherein the predicted time at which the at least one sender receives at least one congestion notification comprises a predicted time at which the at least one sender receives or processes at least one congestion notification.

20. The computer-readable medium of claim 16, wherein the network interface device comprises one or more of: network interface controller (NIC), SmartNIC, router, switch, forwarding element, infrastructure processing unit (IPU), or data processing unit (DPU).
